(19) United States
(12) Patent Application Publication
(10) Pub. No.: US 2023/0390675 A1
(43) Pub. Date: Dec. 7, 2023

(54) ICE PRESSURE COMPENSATION ELEMENT

(71) Applicant: Robert Bosch GmbH, Stuttgart (DE)

(72) Inventors: Matthias De Monte, Leonberg (DE); Gerhard Mack, Stuttgart (DE); Praveen Raj Boopathy, Ludwigsburg (DE); Javier Fernandez Garcia, Madrid (ES); Ruben Alfaro Rodriguez, Madrid (ES)

(21) Appl. No.: 18/322,152

(22) Filed: May 23, 2023

(30) Foreign Application Priority Data
Jun. 1, 2022 (DE) 10 2022 205 625.6

(51) Int. Cl. B01D 35/14; B01D 35/02

(52) U.S. Cl. CPC B01D 35/14; B01D 35/02

(57) ABSTRACT

A compensation element, in particular a filter system, that is configured for volume compensation for a freezing medium. The compensation element includes an elongated hollow body with a first end and a second end, at the first end a coupling area being situated which closes the hollow body, and the second end in particular being open, the compensation element having an elastically reversible design in order to return back to the initial state after a deformation from an initial state that has taken place due to ice formation by the medium, and the hollow body having a cross section with a circumferentially closed outer area, and including an inner structure that is situated at an inner circumference of the outer area.

### FIELD

The present invention relates to a compensation element, in particular of a filter system, that is configured for volume compensation for a freezing medium, in particular urea solutions or aqueous solutions or water, and a filter system that includes such a compensation element.

### BACKGROUND INFORMATION

Filter systems including a compensation element are described in the related art. With liquid media, at low temperatures there is a risk of ice formation which may result in damage to components. In particular in filter systems for DeNOx units of vehicles, there is a high risk of damage to the filter systems due to ice formation. Therefore, for the filter systems, for example for liquid urea solutions for catalytic reduction of nitrogen oxides in internal combustion engines (DeNOx), it is known to situate a compensation element inside the filter system; the compensation element is not filled with liquid, but, rather, is elastically deformable. When there is an increase in volume in the filter system due to ice formation, the compensation element is compressed by the additional volume of the freezing medium, and thus prevents an excessive pressure increase and damage to the filter system. A compensation element of this type is described in German Patent Application No. DE 10 2017 203 796 A1, for example.

### SUMMARY

A compensation element according to the present invention, which is configured for a volume compensation for freezing fluid medium, in particular urea solution or aqueous solutions or water, may have an advantage over the related art that damage of components, which may occur due to a volume expansion of the freezing medium, may be reliably prevented. The compensation element has a simple and cost-effective design. In addition, the compensation element according to the present invention may ensure that after the frozen medium thaws, the compensation element, which has elastically deformed, may completely return back to its original shape. This may be achieved according to an example embodiment of the present invention in that the compensation element includes an elongated hollow body with a first end and a second end, at the first end a coupling area being situated which closes the hollow body, and the second end, for example, being open or including an opening. In this case (i.e., if the second end has an open design or includes an opening to the outside), a gaseous medium situated inside the hollow body may exit through the second, open end during a deformation process of the compensation element. The compensation element has an elastically reversibly deformable design, and after a deformation from an initial state that has taken place due to ice formation by the medium, may return back to its initial state as soon as the frozen medium has once again become liquid. The hollow body has a cross section with a circumferentially closed outer area, and in some cases may include an inner structure which, however, does not absolutely have to be present. This type of inner structure is situated at an inner circumference of the outer area. The inner structure may, for example, extend inwardly from the outer area or may protrude inwardly.

The inner structure advantageously makes it possible for the outer area in particular to be deformed during a deformation of the compensation element. According to an example embodiment of the present invention, during the deformation of the compensation element, the inner structure is not deformed, or is deformed in a predetermined fairly small circumference, preferably with a deformation rate of 30%, in particular of 10%. The inner structure thus provides the compensation element with a certain rigidity that is advantageous for the elastically reversible recovery of the deformed compensation element. In addition, the inner structure prevents the enveloping circumference of the outer area of the deformed cross section (i.e., in particular the outer area or the outer structure) from greatly deviating from the enveloping circumference of the outer area of the undeformed cross section. This yields the advantage that during compression of the hollow body, the outer area does not strike against other (design) elements of the filter system from the inside, for example a filter medium (for example, a filter paper or the like) of a filter element, since the hollow body may be situated inside the filter element, for example. Damage to other design elements, for example a filter medium, by the compressed hollow body is advantageously prevented in this way. For the case that in one exemplary embodiment no inner structure is provided, setpoint kinks, for example in the form of hinges, film hinges, or the like, may be provided in the outer area. This may yield an advantage that the compressed hollow body has a defined enveloping circumference that corresponds approximately to that of the uncompressed hollow body. In this way, even for hollow bodies without an inner structure, the situation may advantageously be prevented that, for example, the compressed hollow body with its outer area strikes against other elements, for example a filter medium of a filter element.

In particular when the compensation element is used with a filter system, damage to the components of the filter system when ice forms inside the filter system may be prevented.

Preferred refinements and example embodiment of the present invention are disclosed herein.

According to an example embodiment of the present invention, the outer area and the inner structure of the compensation element are preferably made of the same material. Ethylene propylene diene monomer (EPDM) or a hydrogenated acrylonitrile butadiene rubber (HNBR), or silicone elastomers or thermoplastic elastomers or thermoplastic vulcanizates (TPVs), are particularly preferably used as material for the compensation element.

According to an example embodiment of the present invention, the outer area and the inner structure of the compensation element particularly preferably have a one-piece design. On the one hand, manufacture with the aid of injection molding, which is particularly cost-effective and easy, may thus be made possible. On the other hand, no further assembly steps are then necessary for manufacturing the compensation element.

According to an example embodiment of the present invention, the inner structure of the compensation element is preferably designed in such a way that a geometric shape of the inner structure when the compensation element changes shape remains essentially undeformed or unchanged, and the outer area of the compensation element is designed in such a way that the deformation takes place primarily or predominantly (by more than 50%) or solely at the outer area. This may mean, for example, that, taking into account all distances or deformation distances, during the deformation the individual sections of the hollow body cover, for example, more than 70% of the deformation distances, preferably more than 85% of the deformation distances, in the outer area. For example, when the sections are subdivided into discrete length sections of 0.5 mm or 1 mm, for example (or some other suitable discretization), the length sections may be summed to determine how much the individual discrete sections have been displaced. The sums of these distances from the outer area and inner area or inner structure may then be compared to one another. The (essentially) undeformed inner structure thus allows the outer area to be completely, reversibly returned back to its initial position after a deformation. The inner structure imparts high rigidity to the compensation element, so that in particular even bending of the compensation element during the deformation process, which could result in the compensation element pressing against adjoining components, may be avoided.

Particularly good reversibility of the compensation element may be achieved when preferably the inner structure and the outer area have a constant, equal wall thickness.

According to an example embodiment of the present invention, it is further preferred that at the main body at the second end, the compensation element includes a radially outwardly directed flange area that preferably has a circumferential design. The flange area is preferably used to fasten the compensation element, in particular in a filter system.

According of an example embodiment of the present invention, for the case that the second end has an open design, it is further preferred that the open second end of the compensation element is configured to accommodate a pressure compensation element. The pressure compensation element may be designed, for example, as a valve element that preferably enables a continuous pressure compensation between the inner area of the compensation element and the surroundings. The pressure compensation element is preferably connected to the open second end of the compensation element with the aid of a clip connection or the like. It is understood that there may also be specific embodiments in which no pressure compensation element is provided. In such a case, for example the hollow body may have a design that is closed toward the outside. In this case, in the event of freezing of the medium, for example a urea solution or some other aqueous solution or water, only the gas volume present in the hollow body would be compressed, and correspondingly re-expands after the medium thaws.

According to an example embodiment of the present invention, it is further preferred that the hollow body of the compensation element includes one or multiple protrusions at the outer circumference, adjacent to the second end. In particular when the radially outwardly directed flange area is also formed at the second end, spacings are preferably present between the protrusions and the flange area, so that a groove is formed between the flange area and the protrusions. The groove is used in particular to accommodate a sealing element, for example an O-ring.

According to an example embodiment of the present invention, the hollow body of the compensation element particularly preferably has a cylindrical design, and the outer area of the hollow body includes a plurality of flat areas that extend in the axial direction of the hollow body. Three flat areas that extend over the entire axial length of the hollow body are particularly preferably provided. The flat areas also preferably extend partially in the coupling area. This has the advantage that during an ice-related deformation of the compensation element, the closure cap is also at least partially deformed, so that no unnecessary high stresses are introduced into the compensation element during the deformation process.

According to an example embodiment of the present invention, the hollow body particularly preferably includes exactly three flat areas at the outer area, and the inner structure includes exactly three wall areas that extend in the longitudinal direction and that meet in a center axis of the compensation element. The three wall areas preferably have an identical design, and have a wall thickness that corresponds to the wall thickness of the hollow body. It is further preferred that a thickening, in particular a thickening having a circular cross section, is provided at the meeting point of the three wall areas of the inner structure. The stability of the inner structure may be further improved in this way. Advantages also result during an injection molding process.

Alternatively, according to an example embodiment of the present invention, the hollow body of the compensation element has a cylindrical or truncated cone-like shape, and the inner structure extending in the longitudinal direction includes three areas in such a way that the compensation element in the undeformed state includes a tripod cavity with three hollow areas having the same design, the three hollow areas meeting in the center axis of the compensation element and being offset in each case by 120°. The inner structure thus includes three inwardly directed triangles, the side of the triangle directed toward the hollow body having a curved design. The other two sides of the triangle form an angle of approximately 120°.

As a further alternative, according to an example embodiment of the present invention, the hollow body of the compensation element has a cylindrical or truncated cone-like shape, and the inner structure extending in the longitudinal direction includes four protruding areas in such a way that the hollow body in the undeformed state includes a cross-shaped cavity with four hollow areas that have the same design and meet in the center axis. The hollow areas are situated adjacent to one another at an angle of 90° in each case. The inner structure thus includes four inwardly directed structural areas that have a triangular design, one side of the triangle that is directed toward the hollow body having a curved design, and the other two sides being straight and forming a 90° angle between them.

As a further alternative, according to an example embodiment of the present invention, the hollow body of the compensation element is designed as a cylinder or as a truncated cone, and the inner structure extending in the longitudinal direction has a cross-shaped design with four wall areas situated at 90° angles relative to one another, the four wall areas meeting in the center axis of the compensation element. The inner structure in cross section thus forms a cross.

According to one alternative embodiment, the present invention relates to a compensation element that is configured for volume compensation for a freezing medium, the compensation element including an elongated hollow body with a first end and a second end. A coupling area that closes the hollow body is situated at the first end, and the second end is open. The compensation element has an elastically reversible design in order to return back to the initial state, even in the event of a deformation from an initial state that has taken place due to ice formation by the medium. The hollow body has a cross section that includes an outer area, the outer area being cylindrical or truncated cone-like, and at the outer area a plurality of flat areas being present that extend in the axial direction of the hollow body. Three flat areas are preferably provided at the outer area. The hollow body of the alternative compensation element thus includes no inner structure. However, due to providing the flat areas, this alternative embodiment likewise allows a secure elastic and reversible deformation of the hollow body in the event of ice formation.

Moreover, the present invention relates to a filter system of a liquid filter, in particular for liquid urea solutions for internal combustion engines (DeNOx), which includes a compensation element according to the present invention. The compensation element is preferably situated inside a filter insert of the filter system. The compensation element is particularly preferably fastened directly to a filter housing, preferably with the aid of a clip connection.

According to an example embodiment of the present invention, it is further preferred that the inner structure is connected to the closure cap. A cross section of this connection between the inner structure and the closure cap preferably has a design that is different from the actual cross section of the inner structure, and is designed as a rod-shaped connection, for example.

### BRIEF DESCRIPTION OF THE DRAWINGS

Preferred exemplary embodiments of the present invention are described in greater detail below with reference to the figures.

FIG. 1 shows a schematic sectional view of a filter system including a compensation element according to a first preferred exemplary embodiment of the present invention.

FIG. 2 shows a schematic perspective view of the compensation element from FIG. 1.

FIG. 3A shows a sectional view of the compensation element along line A-A from FIG. 2 in the undeformed initial state.

FIG. 3B shows a sectional view corresponding to FIG. 3A in the deformed state.

FIG. 4A shows a sectional view of a compensation element according to a second exemplary embodiment of the present invention in the initial state.

FIG. 4B shows a sectional view corresponding to FIG. 4A in the deformed state.

FIG. 5A shows a sectional view of a compensation element according to a third exemplary embodiment of the present invention in the initial state.

FIG. 5B shows a sectional view corresponding to FIG. 5A in the deformed state.

FIG. 6A shows a sectional view of a compensation element according to a fourth exemplary embodiment of the present invention in the initial state.

FIG. 6B shows a sectional view corresponding to FIG. 6A in the deformed state.

FIG. 7A shows a sectional view of a compensation element according to a fifth exemplary embodiment of the present invention in the initial state.

FIG. 7B shows a sectional view corresponding to FIG. 7A in the deformed state.

### DETAILED DESCRIPTION OF EXAMPLE EMBODIMENTS

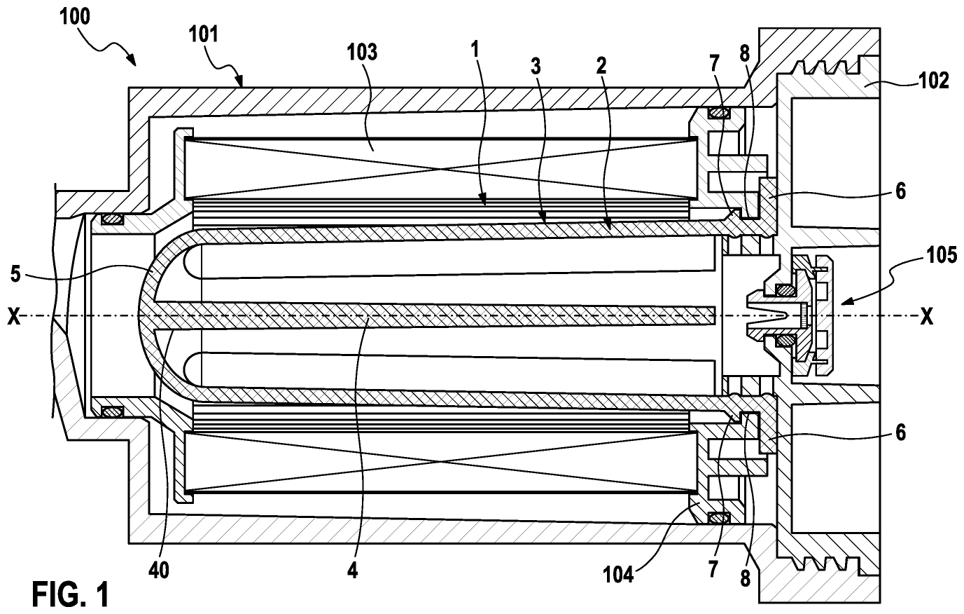

A gas-filled compensation element 1 and a filter system 100 according to a first preferred exemplary embodiment of the present invention are described in greater detail below, with reference to FIGS. 1, 2, 3A, and 3B.

FIG. 1 shows a schematic sectional view of filter system 100, which is used in a system for liquid urea solutions for catalytic reduction of nitrogen oxides in the field of internal combustion engines (DeNOx). However, the filter system is suited for all fluid media, in particular also water and aqueous solutions, which are able to freeze.

As is apparent from FIG. 1, filter system 100 has a design with a cup-like filter housing 101 and a cover 102. A filter medium 103 is situated inside filter housing 101. Compensation element 1 is situated inside filter medium 103. Filter system 100 also includes a retaining ring 104, which in particular retains filter medium 103. In addition, a pressure compensation element 105, which acts as a valve to allow a gas exchange between an inner space of the compensation element and a surroundings side, is situated in cover 102. Filter medium 103 may be part of a replaceable filter element (in the present case, without a reference numeral), which among other things includes retaining ring 104 (as a type of upper or first end cap) and often also a lower or second end cap (in the present case, also without a reference numeral). Filter medium 103 may be a filter paper, for example, such as a filter paper folded in a star shape, or may be made of melt-blown material.

As is apparent from FIG. 1, compensation element 1 is fixed in filter system 100 only on one side. If ice formation should occur inside filter system 100, compensation element 1 is elastically reversibly deformed in order to provide a volume compensation for the freezing medium in filter system 100.

After ice formation in filter system 100, which results in an increase in volume of the freezing medium, compensation element 1 may thus undergo a deformation, it being possible for the gas situated inside compensation element 1 to be emitted to the surroundings via pressure compensation element 105.

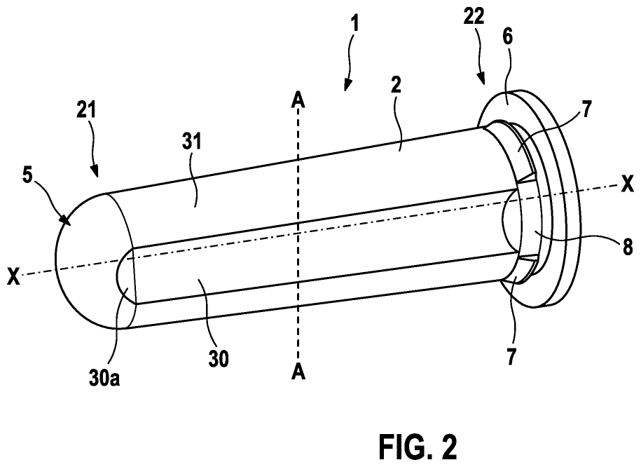

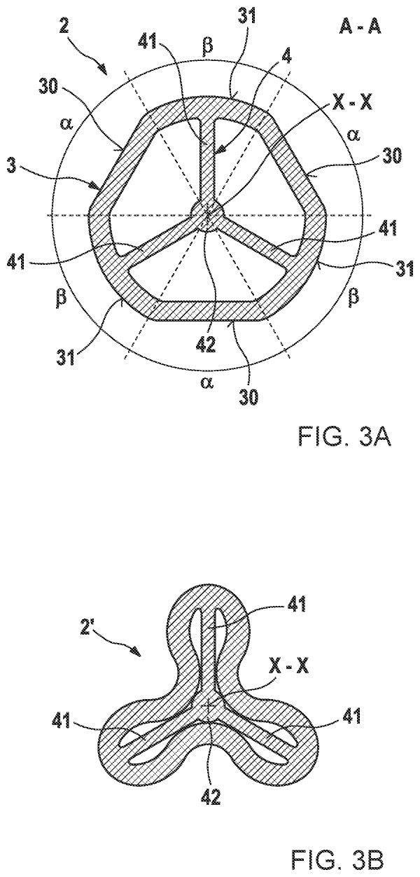

Compensation element 1 is apparent in the detail from FIGS. 2, 3A, and 3B. Compensation element 1 includes an elongated hollow body 2 which has an essentially hollow cylindrical, or alternatively a hollow truncated cone-like, design. Hollow body 2 includes a first end 21 and a second, open end 22.

A closure cap 5 that closes the inner cavity of hollow body 2 is situated at first end 21. Second end 22 has an open design, strictly as an example here, in order to provide a gas connection to pressure compensation element 105.

FIGS. 3A and 3B each show a cross section along line A-A from FIG. 2. FIG. 3A shows the undeformed state of compensation element 1, and FIG. 3B shows a maximally deformed state of compensation element 1 after ice formation at the outer circumference of compensation element 1.

As is apparent from FIG. 3A, hollow body 2 includes a circumferentially closed outer area 3 and an inner structure 4 that extends in the longitudinal direction of the hollow body.

Inner structure 4 is situated inside outer area 3, and has a one-piece design with outer area 3. Outer area 3 and inner structure 4 are thus made of the same material, preferably with the aid of an injection molding process.

Outer area 3 in principle has a hollow cylindrical shape, or alternatively, a shape of a hollow truncated cone, outer area 3 including multiple flat areas 30. As is apparent from FIG. 3A, this results in a design such that flat areas 30 and cylindrical areas 31 alternate along the circumference of outer area 3. In this exemplary embodiment, exactly three flat areas 30 and three cylindrical areas 31 are provided. Flat areas 30 are formed over an angle α of 60° along the outer circumference of the outer area, and cylindrical areas 31 are formed along an angle β of likewise 60° along the outer circumference of the outer area.

Inner structure 4 includes exactly three wall areas 41 which meet in a center axis X-X of compensation element 1. A core area 42 having a circular cross section is situated in center axis X-X, as the result of which the connection between wall areas 41 is reinforced. Wall areas 41 are uniformly situated along the circumference at an angle of 120° in each case, and extend up to the level of closure cap 5.

As is further apparent from FIG. 3A, wall areas 41 contact outer area 3 at the inner side of cylindrical areas 31. There is no contact between inner structure 4 and flat areas 30 of outer area 3.

FIG. 3B explains the compressed state of compensation element 1 in the event of ice formation at the outer circumference of hollow body 2. The compressed hollow body is denoted by reference numeral 2′ in FIG. 3B. As is apparent from FIG. 3B, inner structure 4 of compensation element 1 remains unchanged, i.e., without deformation. Outer area 3 deforms in particular at flat areas 30, which are not in contact with inner structure 4. At maximum deformation, which is illustrated in FIG. 3B, flat areas 30 may deform until they make contact with core area 42. Cylindrical areas 31 are likewise deformed; however, due to the curvature of the cylindrical areas, direct contact between deformed cylindrical areas 31 and inner structure 4 is prevented from occurring, in particular at the attachment area between inner structure 4 and outer area 3. In particular, an irreversible adhesion of deformed cylindrical areas 31 to inner structure 4 is thus prevented.

As illustrated in FIG. 1, inner structure 4 is connected to closure cap 5 via a rod-shaped connection 40, which in this exemplary embodiment is a short cylindrical section. In this exemplary embodiment, the configuration is such that flat areas also include a small portion 30a that is formed at closure cap 5 (cf. FIG. 2). In the event of ice formation, coupling area 5 is thus also deformed slightly, so that excessively large stresses between deformed outer area 3 and closure cap 5 may be avoided.

As is further apparent from FIGS. 1 and 2, a flange area 6 is provided at open end 22 of hollow body 2. Flange area 6 extends circumferentially and radially outwardly from hollow body 2. Flange area 6 is used in particular to fix compensation element 1 to filter system 100.

As is apparent from FIG. 2, multiple protrusions 7 are provided at outer area 3. A groove 8 is provided between protrusions 7 and flange area 6. In this exemplary embodiment, three protrusions 7 are situated at the outer circumference of outer area 3, protrusions 7 being situated in the region of cylindrical areas 31.

As is apparent from FIG. 1, a connection with retaining ring 104 at groove 8 is established by clipping in. Compensation element 1 is thus clamped to retaining ring 104 on one side. First end 21 is freely positioned in filter system 100.

It is noted that for secure sealing between an inner space of filter system 100 and the surroundings, additional sealing elements, for example O-rings or the like, may also be provided at second end 22.

The material of one-part compensation element 1 is preferably EPDM.

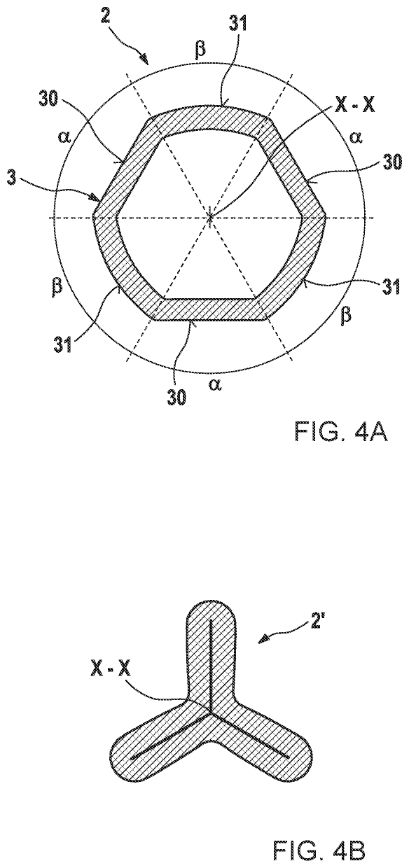

FIGS. 4A and 4B show a compensation element 1 according to a second exemplary embodiment of the present invention. Identical or functionally equivalent parts are denoted by the same reference numerals as in the preceding exemplary embodiment.

The second exemplary embodiment corresponds essentially to the first exemplary embodiment, compensation element 1 including a hollow body 2 that includes only an outer area 3. Hollow body 2 of the second exemplary embodiment thus includes no inner structure. Outer area 3 is designed as in the first exemplary embodiment, with three flat areas 30 and three cylindrical areas 31. The completely deformed state is illustrated in FIG. 4B.

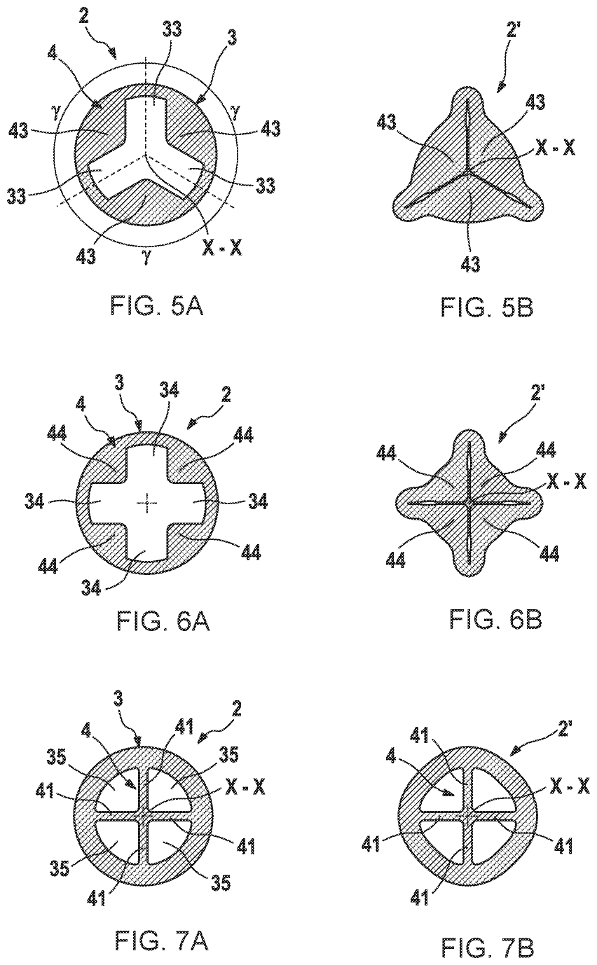

FIGS. 5A and 5B show a third exemplary embodiment of the present invention, identical or functionally equivalent parts being denoted by the same reference numerals as in the preceding exemplary embodiments.

As is apparent from FIG. 5A, hollow body 2 includes a cylindrical outer area 3, and three triangular areas 43 as inner structure 4. Triangular areas 43 extending in the longitudinal direction have a triangular shape with a curved side situated at the inner circumference of outer area 3, and two straight sides having an angle of 120° between them. The three triangular areas 43 are uniformly distributed along the inner circumference of outer area 3, and have a one-piece design with outer area 3. This results in three hollow areas 33 inside hollow body 2, which meet in center axis X-X. This results in a tripod cavity inside hollow body 2 in the undeformed state of compensation element 1. FIG. 5B shows the compressed state during ice formation, hollow body 2′ being compressed in such a way that the three triangular areas 43 remain undeformed, and the deformation takes place solely at outer area 3 situated between the three triangular areas 43. The three triangular areas 43 may touch one another in the completely deformed state.

FIGS. 6A and 6B show a compensation element 1 according to a fourth exemplary embodiment of the present invention. Identical or functionally equivalent parts are once again denoted by the same reference numerals as in the preceding exemplary embodiments.

As is apparent from FIG. 6A, hollow body 2, similarly as for the third exemplary embodiment, includes a cylindrical outer area 3, and four triangular areas 44 as inner structure 4. The four triangular areas 44 extending in the longitudinal direction are adjacently situated at an angle γ of 90° in each case. Similarly as for the third exemplary embodiment, triangular areas 44 have a triangular shape with a curved side that is in contact with the inner circumference of outer area 3 and that has a one-piece design with outer area 3. The other two sides of triangular area 44 have a straight design and form a right angle between them. This results in a cavity inside hollow body 2 which includes four hollow areas 34 that meet at center axis X-X of compensation element 1. As illustrated in the completely compressed state in FIG. 6B, the four hollow areas 34 completely disappear when hollow body 2 is compressed by ice formation. A very intense deformation occurs in the outer area, at whose inner side the four hollow areas 34 are formed.

FIGS. 7A and 7B show a compensation element 1 according to a fifth exemplary embodiment of the present invention. Identical or functionally equivalent parts are once again denoted by the same reference numerals as in the preceding exemplary embodiment.

The fifth exemplary embodiment includes a hollow body 2 with a cylindrical outer area 3 and inner structure 4, designed as a cross, extending in the longitudinal direction. Inner structure 4 once again has a one-piece design with outer area 3. Inner structure 4 includes four wall areas 41 that are each situated at a right angle relative to one another. This results in four hollow areas 35 that are in contact with one another only at the respective ends of hollow body 2. At maximum deformation, illustrated in FIG. 7B, only slight deformations of compensation element 1 result, since compensation element 1 is very rigid due to cross-shaped inner structure 4. This results in a slight compression of inner structure 4 in the area of center axis X-X of compensation element 1. In comparison to the preceding exemplary embodiments, a compensation function of the fifth exemplary embodiment in the event of ice formation is thus reduced.

1-15. (canceled)

16. A compensation element including a filter system configured for volume compensation for a freezing medium, the compensation element comprising:
an elongated hollow body with a first end and a second end, at the first end, a coupling area being situated which closes the hollow body, and the second end being open;
wherein the compensation element has an elastically reversible configuration to return back to an initial state after a deformation from the initial state that has taken place due to ice formation by the medium, and
wherein the hollow body has a cross section with a circumferentially closed outer area, and includes an inner structure that extends in a longitudinal direction and that is situated at an inner circumference of the outer area.

17. The compensation element as recited in claim 16, wherein the outer area and the inner structure are made of the same material.

18. The compensation element as recited in claim 16, wherein the outer area and the inner structure have a one-piece configuration, as an injection-molded part.

19. The compensation element as recited in claim 16, wherein the inner structure is configured in such a way that a geometric shape of the inner structure remains essentially unchanged in the event of ice formation, and the outer area is configured n such a way that the deformation takes place predominantly or solely at the outer area.

20. The compensation element as recited in claim 16, wherein the inner structure and the outer area have a constant, identical wall thickness.

21. The compensation element as recited in claim 16, wherein the hollow body at the second end includes a radially outwardly directed flange area.

22. The compensation element as recited in claim 16, wherein a pressure compensation element that closes the second end is situated at the second end.

23. The compensation element as recited in claim 16, wherein the hollow body includes protrusions at an outer circumference, adjacent to the second end, that are configured to fix the compensation element.

24. The compensation element as recited in claim 16, wherein the hollow body is cylindrical or truncated cone-like, and the outer area includes a plurality of flat areas that extend in a direction of a center axis of the hollow body.

25. The compensation element as recited in claim 24, wherein the hollow body includes exactly three flat areas at the outer area, and the inner structure includes three wall areas that meet in the center axis of the compensation element and are situated adjacent to one another at an angle of 120°.

26. The compensation element as recited in claim 16, wherein the hollow body has a cylindrical or truncated cone-like configuration, and the inner structure includes three inwardly protruding triangular areas in such a way that the compensation element in an undeformed state includes a tripod cavity with three hollow areas that have the same configuration, and that meet in a center axis of the hollow body and are each offset relative to one another by 120°.

27. The compensation element as recited in claim 16, wherein the hollow body has a cylindrical or truncated cone-like configuration, and the inner structure includes four inwardly protruding triangular areas in such a way that the hollow body in an undeformed state includes a cross-shaped cavity with four hollow areas that meet in a center axis of the hollow body and in each case are spaced apart from one another by 90°.

28. The compensation element as recited in claim 16, wherein the hollow body has a cylindrical or truncated cone-like configuration, and the inner structure has a cross-shaped configuration with four wall areas that are situated at an angle of 90° relative to one another and that meet in a center axis of the hollow body.

29. A compensation element including a filter system configured for volume compensation for a freezing medium, the compensation element comprising:
an elongated hollow body with a first end and a second end, at the first end, a coupling area being situated which closes the hollow body, and the second end being open;
wherein the compensation element has an elastically reversible configuration to return back to an initial state after a deformation from the initial state that has taken place due to ice formation by the medium, and
wherein the hollow body has a cross section with a circumferentially closed outer area, the hollow body including three flat areas at the outer area and three cylindrical areas at the outer area that are situated in alternation along the circumference, and have the same arc length along the circumference of the hollow body, the arc length being 60°.

30. A filter system including a DeNOx filter system, comprising:
a compensation element situated inside a filter medium, the compensation element being configured for volume compensation for a freezing medium, the compensation element including:
an elongated hollow body with a first end and a second end, at the first end, a coupling area being situated which closes the hollow body, and the second end being open;
wherein the compensation element has an elastically reversible configuration to return back to an initial state after a deformation from the initial state that has taken place due to ice formation by the medium, and
wherein the hollow body has a cross section with a circumferentially closed outer area, and includes an inner structure that extends in a longitudinal direction and that is situated at an inner circumference of the outer area.
